(19) United States
(12) Patent Application Publication
(10) Pub. No.: US 2022/0088616 A1
(43) Pub. Date: Mar. 24, 2022

(54) SANITARY FITTING HAVING AT LEAST ONE FIRST FLUID OUTLET AND AT LEAST ONE SECOND FLUID OUTLET

(71) Applicant: Grohe AG, Hemer (DE)

(72) Inventor: Felix MUEHLING, Menden (DE)

(73) Assignee: Grohe AG, Hemer (DE)

(21) Appl. No.: 17/482,665

(22) Filed: Sep. 23, 2021

(30) Foreign Application Priority Data
Sep. 24, 2020 (DE) 102020124931.4

(51) Int. Cl. B05B 1/02; E03C 1/04; B05B 12/18

(52) U.S. Cl. CPC B05B 1/02; B05B 12/18; E03C 1/0404

(57) ABSTRACT

A sanitary fitting (1), containing a fitting housing (2) having at least one first fluid outlet (3) for generating a spray mist (4) and at least one second fluid outlet (5) for generating a jacketed flow (6), which at least partially encompasses the spray mist (4).

This invention relates to a sanitary fitting. Such sanitary fittings are used, in particular, to provide a fluid on demand at a sink, washbasin, shower or bathtub.

Sanitary fittings are used in particular to dispense a fluid for cleaning objects. In particular, when sanitary fittings are used in kitchens, these items may be, for instance, food, such as fruit and/or vegetables. If the fluid is delivered through the sanitary fittings as a full flow or laminar flow, a high consumption of fluid occurs when such objects are cleaned. Therefore, sanitary fittings, which can be used to dispense the fluid in the form of a spray mist or fog spray, are known. A disadvantage of such sanitary fittings, however, is that a part of the spray mist spreads into an environment due to its very fine fluid droplets, i.e., the spray mist also moistens areas where this is not desired.

It is, therefore, the object of the invention to solve at least a part of the issues described with reference to the prior art and, in particular, of providing a sanitary fitting, which can reduce the dispersion of a spray mist to undesired areas.

This object is met by a sanitary fitting according to the features of the independent claim. Further advantageous embodiments of the invention are specified in the dependent claims. It will be appreciated that the features listed individually in the dependent claims may be combined in any technologically useful manner and define further embodiments of the invention. In addition, the features indicated in the claims are further specified and explained in the description, wherein further preferred embodiments of the invention are illustrated.

Contributing thereto is a sanitary fitting having a fitting body with at least a first fluid outlet for generating a spray mist and at least a second fluid outlet for generating a jacketed flow at least partially encompassing the spray mist.

Such sanitary fittings are used in particular to provide a fluid, in particular water at a tap, a sink, a washbasin, a shower and/or a bathtub. The fluid can be mixed water for instance. The mixed water can be mixed by the sanitary fitting, in particular from cold water having a cold-water temperature and hot water having a hot-water temperature. The cold-water temperature is in particular at most 25° C. (Celsius), preferably 1° C. to 25° C., particularly preferably 5° C. to 20° C. and/or the hot-water temperature is in particular at most 100° C., preferably 25° C. to 90° C., particularly preferably 55° C. to 65° C. To this end, the sanitary fitting can have a mixing valve, for instance.

The sanitary fitting has a fitting housing, wherein the fitting housing may be at least partially made of plastic and/or metal, such as brass or a zinc alloy. Further, the fitting housing can be attached to a support, such as a countertop, the sink, the wash basin, or the bathtub. In addition, the fitting housing can have a (protruding or branching) outlet that is rigidly or movably connected to the fitting housing. The outlet can be formed to be at least partially tubular. Further, the fitting body and/or spout may have a decorative outer surface.

The fitting body comprises at least a first fluid outlet (set up) for generating a spray mist. For this purpose, the fluid can be sprayed through the at least one first fluid outlet, in particular in the form of an aerosol and/or, in particular, in the form of a plurality of fluid droplets. For instance, the fluid droplets may have a droplet diameter of no more than 1 mm (millimeter), preferably no more than 0.5 mm, particularly preferably no more than 0.1 mm. In particular, the droplet diameter can be at least 0.001 mm, preferably at least 0.01 mm, or particularly preferably at least 0.1 mm. For instance, the droplet diameter may be 0.001 mm to 1 mm, 0.001 mm to 0.5 mm, or 0.001 mm to 0.1 mm. The spray mist can be sprayed through the at least one first fluid outlet, in particular by at least 0.1 m (meters), preferably by at least 0.3 m from the flow. To generate the spray mist, the fluid can be sprayed through the at least one first fluid outlet at a pressure of at least 3 bar, at least 5 bar, or at least 10 bar, for instance. The at least one first fluid outlet can be designed in particular in the manner of a first nozzle.

Further, the fitting housing comprises at least a second fluid outlet (set up) for generating a jacketed flow that at least partially encompasses the spray mist. For this purpose, the jacketed flow can encompass the spray mist at least partially in a tubular manner and/or, in particular, by 360° relative to a spray direction of the spray mist and/or the jacketed flow. This can mean in particular that the jacketed flow at least partially forms or delimits an (inner) duct, in which the spray mist is in particular guided. For instance, the duct may have a duct diameter of 5 mm to 50 mm, preferably 20 mm to 40 mm. The spray mist can be guided within the jacketed flow, in particular, until the spray mist and/or the jacketed flow hit a basin or an object (to be cleaned). The jacketed flow can be formed from a plurality of individual spray streams. For this purpose, the fluid may exit the at least one second fluid outlet in the form of the plurality of individual spray streams. The spray streams can each have a diameter of less than 2 mm, for instance. The individual spray streams can extend in parallel to each other and/or be spaced less than 2 mm apart, preferably less than 1 mm apart. Furthermore, the individual spray streams can merge outside the at least one second fluid outlet to form the jacketed flow in particular, such that a single spray stream is formed from the individual spray streams. The individual spray streams can be merged, for instance, after a maximum of 20 mm, preferably after a maximum of 10 mm, after exiting the at least one second fluid outlet. The jacketed flow can be formed by the at least one second fluid outlet, in particular, in such a way that a maximum of 25% of the spray mist, preferably a maximum of 10% of the spray mist, particularly preferably a maximum of 5% of the spray mist, or very particularly preferably (largely) no spray mist can escape from the jacketed flow into the environment before striking the basin or the object (to be cleaned). Furthermore, the sanitary fitting can be designed in such a way that the delivery of the spray mist and/or the jacketed flow can be deactivated and instead at least one other type of stream, such as (only) a laminar flow, can be dispensed by the sanitary fitting. For this purpose, the sanitary fitting can, for instance, have a diverter that can be operated by a user.

The at least one second fluid outlet may encompass the at least one first fluid outlet. In particular, this may mean that the at least one second fluid outlet is disposed around the at least one first fluid outlet.

The at least one second fluid outlet may be annular in shape. In particular, the at least one second fluid outlet has a circular ring shape.

The at least one first fluid outlet and the at least one second fluid outlet may be formed coaxially.

The at least one second fluid outlet may be formed by a plurality of nozzles. In particular, the individual nozzles are spaced apart by a maximum of 2 mm, preferably a maximum of 1 mm, and particularly preferably a maximum of 0.5 mm.

The nozzles can be arranged in juxtaposition with each other. In particular, this can mean that there is (largely) no distance between the individual nozzles. Furthermore, this can mean in particular that the individual nozzles are separated from each other only by a partition. The partitions may be, for instance, a part of the fitting body, the spout, a aerator body, and/or separate components of the sanitary fitting. The at least one partition may extend at least partially in a radial direction of the at least one second fluid outlet.

The nozzles can have a ring-segment-shaped cross-section. In this regard, the nozzles may have a length in a circumferential direction of the at least one second fluid outlet that is, for instance, 1 mm to 30 mm, preferably 3 mm to 30 mm, or preferably 5 mm to 30 mm. Further, the nozzles may have a width in radial direction of the at least one second fluid outlet, that is, for instance, 0.5 mm to 5 mm, preferably 0.5 mm to 3 mm.

The jacketed flow can be a laminar flow. A laminar flow is in particular a fluid flow that is bundled and/or consists of only one fluid flow.

The at least one first fluid outlet and the at least one second fluid outlet may be connected to a joint fluid duct. In particular, the at least one first fluid outlet and the at least one second fluid outlet are directly connected to a joint fluid duct. In particular, this may mean that the at least one first fluid outlet and the at least one second fluid outlet cannot be supplied with fluid via separate fluid ducts. In this way, the manufacturing effort of the sanitary fitting can be further reduced.

The at least one first fluid outlet or the at least one second fluid outlet may be formed in an aerator of the sanitary fitting. In particular, the at least one first fluid outlet and/or the at least one second fluid outlet may be formed inside the aerator. The fitting housing or the spout may have an opening that, in particular, connects an interior of the fitting housing and/or spout to an environment of the sanitary fitting. The aerator may be arranged in particular at least partially in the opening of the spout. For instance, the aerator may have a thread that can be used to screw the aerator into the opening. The aerator may have an aerator housing that may be (mainly) cylindrical in shape and/or extend along a longitudinal axis. In particular, the aerator may have a length of 5 mm to 50 mm in parallel to the longitudinal axis and/or a diameter of 5 mm to 50 mm (in particular orthogonal to the longitudinal axis). For instance, the joint fluid duct may be formed in the aerator housing of the aerator.

Thus, in particular, a sanitary fitting proposed herein is used for focusing a generated spray mist or for reducing/preventing the (lateral or radial) exiting of the spray mist from the jacketed flow.

The invention and the technical environment are explained in more detail below with reference to the figures. It should be noted that the figures show a particularly preferred embodiment variant of the invention, but the invention is not limited thereto. The same reference signs are used for the same components in the figures. In an exemplary and schematic manner

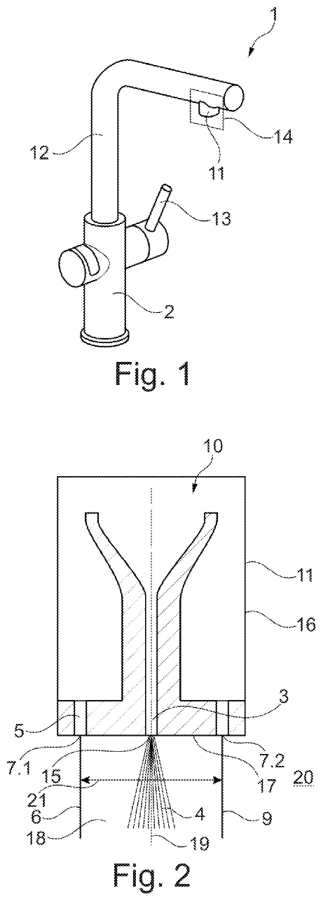

FIG. 1 shows a perspective view of a sanitary fitting;

FIG. 2 shows a longitudinal section of an aerator of the sanitary fitting; and

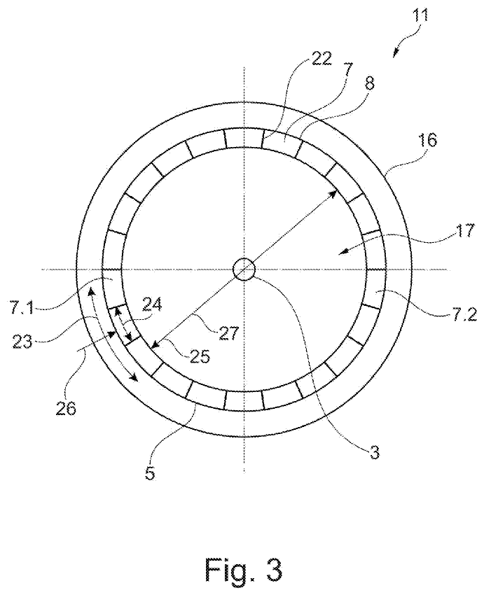

FIG. 3 shows the aerator viewed towards an outlet end.

FIG. 1 shows a perspective view of the sanitary fitting 1. The sanitary fitting 1 has a fitting housing 2 having a spout 12. The fitting housing 2 can be attached to a support not shown here, such as a sink. The spout 12 is attached to the fitting housing 2 in a swiveling manner and has an aerator 11, which in the embodiment variant of the sanitary fitting 1 shown here is screwed to the spout 12. A fluid can be supplied to the aerator 11 via the outlet 12, which fluid can exit the sanitary fitting 1 via the aerator 11. To control a dispensing of the fluid, the sanitary fitting 1 has an actuating element 13 in the form of an actuating lever.

FIG. 2 shows a longitudinal section along the sectional plane 14 shown in FIG. 1 of the aerator 11 of the sanitary fitting 1 shown in FIG. 1. The aerator 11 has an aerator housing 16. Furthermore, the aerator 11 comprises a first fluid outlet 3 for generating a spray mist 4 and a second fluid outlet 5 for generating a jacketed flow 6. The first fluid outlet 3 and the second fluid outlet 5 open at an outlet end 17 of the aerator 11. The first fluid outlet 3 is formed by a first nozzle 15 and the second fluid outlet 5 is formed by a plurality of second nozzles, of which only two second nozzles 7.1, 7.2 are shown in FIG. 2. Fluid can be supplied to the first fluid outlet 3 and the second fluid outlet 5 via a joint fluid duct 10. The jacketed flow 6 emerges from the second fluid outlet 5 in the form of a laminar flow 9, such that the jacketed flow 6 (mainly) completely encompasses or (mainly) envelops the spray mist 4 by 360°. Furthermore, the jacketed flow 6 is tubular having an inner duct 18. The jacketed flow 6 extends in parallel to a longitudinal axis 19 of the aerator 11 and has an annular cross-section of flow. A duct diameter 21 of the duct 18 is (largely) constant and extends in parallel to the longitudinal axis 19. The duct 18 prevents the spray mist 4 from exiting into an environment 20 before the spray mist 4 and the jacketed flow 6 strike a basin not shown here, or an object to be cleaned, also not shown here.

FIG. 3 shows an enlarged view of the aerator 11 with the aerator housing 16 viewed at the outlet end 17. The first fluid outlet 3 and the second fluid outlet 5 are formed coaxially. Moreover, it can be seen in FIG. 3 that the second fluid outlet 5 is formed by a plurality of second nozzles 7, each separated from the other only by a partition 22 and arranged immediately adjacent to each other. Thus, the second fluid outlet 5 is annular in shape and has an inner diameter 27. This can ensure the generation of a closed jacketed flow 6 (cf. FIG. 2) after the fluid has exited the second fluid outlet 5. The second nozzles 7 each have a length 24 in a circumferential direction 23 of the second fluid outlet 5 and a width 26 in a radial direction 25 of the second fluid outlet 5. In addition, the second nozzles 7 each have a ring-segment-shaped cross-section 8.

This invention can prevent the spray mist from spreading to an environment outside the jacketed flow.

### LIST OF REFERENCE NUMERALS

1 sanitary fitting

2 fitting housing

3 first fluid outlet

4 spray mist

5 second fluid outlet

6 jacketed flow

7, 7.1, 7.2 second nozzle

8 cross section

9 laminar beam

10 fluid duct

11 aerator

12 outlet

13 actuating element

14 sectional plane

15 first nozzle

16 aerator housing

17 outlet end

18 duct

19 longitudinal axis

20 environment

21 duct diameter

22 partition wall

23 peripheral direction

24 length

25 radial direction

26 width

27 inner diameter

1. A sanitary fitting (1), comprising a fitting housing (2) having at least one first fluid outlet (3) for generating a spray mist (4) and at least one second fluid outlet (5) for generating a jacketed flow (6), which at least partially encompasses the spray mist (4).

2. The sanitary fitting (1) according to claim 1, wherein the at least one second fluid outlet (5) encompasses the at least one first fluid outlet (3).

3. The sanitary fitting (1) according to claim 1, wherein the at least one second fluid outlet (5) is annular in shape.

4. The sanitary fitting (1) according to claim 1, wherein the first outlet (3) and the second outlet (5) are arranged coaxially.

5. The sanitary fitting (1) according to claim 1, wherein the at least one second fluid outlet (5) is formed by a plurality of nozzles (7, 7.1, 7.2).

6. The sanitary fitting (1) according to claim 5, wherein the nozzles (7, 7.1, 7.2) are arranged in juxtaposition to each other.

7. The sanitary fitting (1) according to claim 5, wherein the nozzles (7, 7.1, 7.2) have a ring-segment-shaped cross-section (8).

8. The sanitary fitting (1) according to claim 1, wherein the jacketed flow (6) is a laminar flow (9).

9. The sanitary fitting (1) according to claim 1, wherein the at least one first fluid outlet (3) and the at least one second fluid outlet (5) are connected to a joint fluid duct (10).

10. The sanitary fitting (1) according to claim 1, wherein the at least one first fluid outlet (3) or the at least one second fluid outlet (5) are formed inside an aerator (11) of the sanitary fitting (1).
